(19) United States
(12) Patent Application Publication
(10) Pub. No.: US 2020/0336101 A1
(43) Pub. Date: Oct. 22, 2020

(54) CLEANING METHODS FOR SOLAR PANELS

(71) Applicant: PASCO Ventures LLC, Highlands Ranch, CO (US)

(72) Inventor: Paul A. Stewart, Highlands Ranch, CO (US)

(73) Assignee: PASCO Ventures LLC

(21) Appl. No.: 16/386,349

(22) Filed: Apr. 17, 2019

(51) Int. Cl. H02S 40/12; B08B 6/00; B08B 7/00

(52) U.S. Cl. CPC H02S 40/12; B08B 7/0071; B08B 6/00

(57) ABSTRACT

Methods for cleaning solar panels when snow, ice, or dust accumulation on the solar panels reduces or eliminates the electrical power output from the solar panels. The methods of cleaning include the incremental and sequential selection of cleaning areas having obstructed solar panels, and the incremental and sequential activation of cleaning devices for the selected solar panels. The cleaning devices for the sequentially selected and obstructed solar panels may be powered by the prior solar panels that have been cleaned.

### TECHNICAL FIELD

The disclosure is directed to photovoltaic or solar panels, and particularly to methods for cleaning the panels.

### BACKGROUND

The conversion of sunlight into electricity, i.e., solar power, continues to be a popular source of energy. Solar cell or panel arrays may include a few or thousands of solar cells and panels that are positioned on or near buildings or across large tracts of land. The performance of such solar cell and panel arrays may be diminished substantially because of snow, ice, or dust which decreases the ability of the solar cells to receive sunlight.

If snow, ice, or dust accumulate on the solar cells and panels, the sunlight may be prevented from reaching the solar cells thereby preventing the solar cells from generating power until the snow or ice melts or the dust is removed. In certain regions, there may be several sunny days after snow or ice storms, but the accumulation of snow or ice that does not melt, prevents the solar panels from operating normally.

Certain prior solar cell cleaning methods and apparatus use water to clean the solar panels. This approach is not practical when there is snow and/or ice or for solar panels installed in the desert. Other approaches have used electrostatic fields to repel dust or the creation of air-flow over the surface of the solar panels. While these or other prior solar cell cleaning methods and apparatus have been proposed, there still remains a need for an improved method for cleaning solar cells and panels particularly when snow, ice, or dust accumulate on the solar panels thereby reducing or eliminating the electrical output.

### SUMMARY

The present invention relates to methods for cleaning solar panels and reducing power consumption during the cleaning of snow, ice, or dust from solar panels. By using the disclosed methods with larger solar panel arrays, the power consumption for cleaning may be reduced to a relatively small amount that may be produced in whole or in part by the solar panels.

The methods of the present invention remove snow, ice, or dust from obstructed solar panels by using either heated cleaning devices; electromagnetic/electrostatic cleaning devices; or combination devices which provide both heating and electromagnetic/electrostatic outputs. Sensors determine when the solar panels are obstructed to an unacceptable level by snow, ice, or dust thereby preventing the panels from generating a normal electrical output. Depending on the kind and location of the obstruction, groups of selected and heated cleaning devices are activated to melt snow and ice or groups of selected electromagnetic/electrostatic cleaning devices are activated to remove dust. The groups of cleaning devices are incrementally and sequentially activated until the surfaces of the solar panel array are clean.

In accordance with the methods of the present invention, only a portion, i.e., as few as one, of the cleaning devices, from the selected group of solar panels, are initially (first) activated when the solar panels are obstructed by snow, ice, or dust. Thereafter, when the first selected solar panel(s) are cleared of obstruction, a second group of obstructed solar panels, i.e., as few as one, are incrementally and sequentially selected, and the cleaning devices associated with those subsequently selected solar panels are activated.

The method of incrementally and sequentially selecting obstructed solar panels, and activating the cleaning devices for the selected solar panels, continues until the entire solar panel array is cleaned. The cleaning devices for the incrementally and sequentially selected obstructed panels may be powered by the prior solar panels that have been cleaned. Thus, the electrical power generated by the cleaned solar panels is used in whole or in part to power the cleaning devices for the next group of selected, obstructed solar panels.

The sensors are used to detect information such as the location, size, and type of obstruction on the solar panels. This information and other information are evaluated by a controller before selecting cleaning locations on the solar panel array and before activating the selected cleaning devices. The controller evaluates information including the power output of the solar panels; information from the sensors regarding the type and location of the obstruction; the date, time, and temperature; and the current weather conditions and weather forecasts.

The collected information is processed by the controller for the purposes of determining: the type and extent of the obstruction; a location for the cleaning area where one or more of the cleaning devices are activated; and the type of cleaning device to be used for removing the obstruction.

These and other aspects of the present invention will be understood from the following detailed description of the embodiments and appended claims with the drawings.

### BRIEF DESCRIPTION OF THE DRAWINGS

FIG. 1 is a schematic side view of a solar panel.

FIG. 2 is a top view schematic of a solar panel group.

FIG. 3 is a schematic view of a solar panel array electrically connected together.

FIG. 4 is a perspective view of a solar panel with a cleaning device.

FIG. 5 is a side schematic view of a solar panel with a cleaning device.

FIG. 6 is a side schematic view of a solar panel with a cleaning device.

FIG. 7 is a block diagram of a controller connected to alternative cleaning devices.

FIG. 8 is schematic view of an example embodiment of a cleaning device associated with a solar panel.

### DETAILED DESCRIPTION

Reference will now be made to the drawings where embodiments of the methods of the present invention are illustrated. It will be apparent to one of ordinary skill in the art that various modifications and variations can be made in the present invention without departing from the scope of the invention. It is intended that the present invention covers such modifications and variations as exist within the scope of the appended claims and their equivalents.

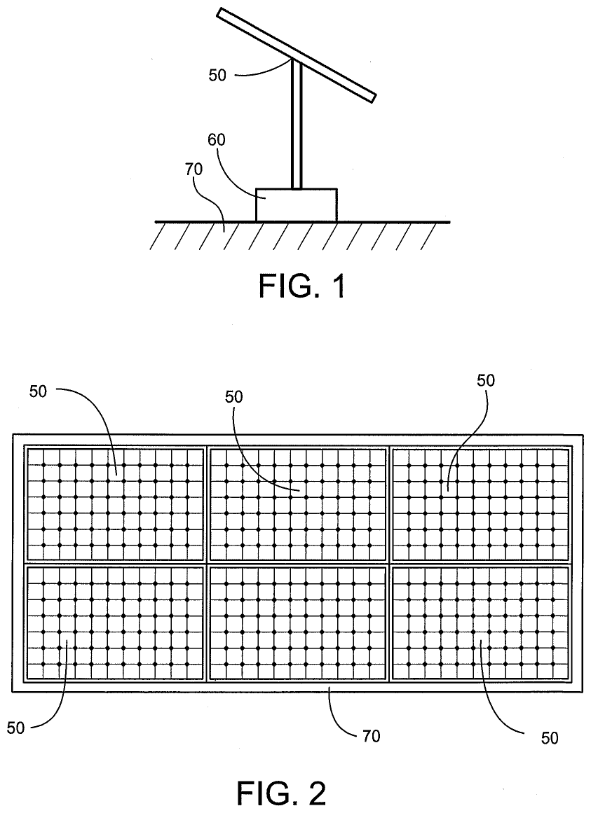

The present invention provides methods to improve photovoltaic (solar) cell performance. FIGS. 1-3 illustrate a plurality of solar cell panels 50 and a representative panel support structure 60. As is schematically illustrated in FIG. 1, the solar panels 50 are positioned at a desired location on a base 70. The solar cell panels 50 are adjustable such that they may be set at a desired position relative to the sun. Further, as shown in FIG. 2, the solar panels 50 may be arranged in one or more groups wherein the groups of solar panels may be connected together to make an array of solar panels.

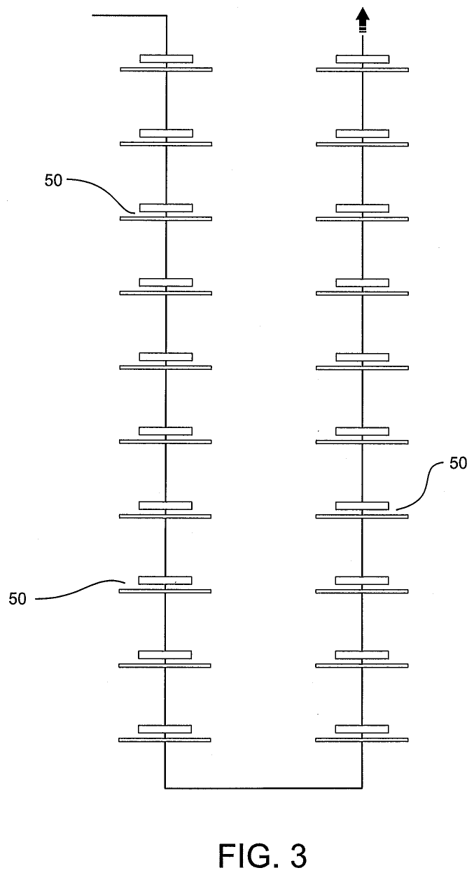

As schematically shown in FIG. 3, the solar panels 50 may be electrically connected in series as a solar panel array. As is conventional, a solar panel array may include a few or even thousands of photovoltaic cells that are positioned near or on buildings or across large and diverse tracts of land.

As is known, the performance of individual solar panels, groups of solar panels, or solar panel arrays, may be diminished because of snow, ice, or dust which decreases the ability of the solar cells to receive sunlight. While there have been prior disclosures of cleaning apparatus for solar panels, there remains a need for an improved method for cleaning solar cells while minimizing the amount of power required to operate the cleaning method or apparatus.

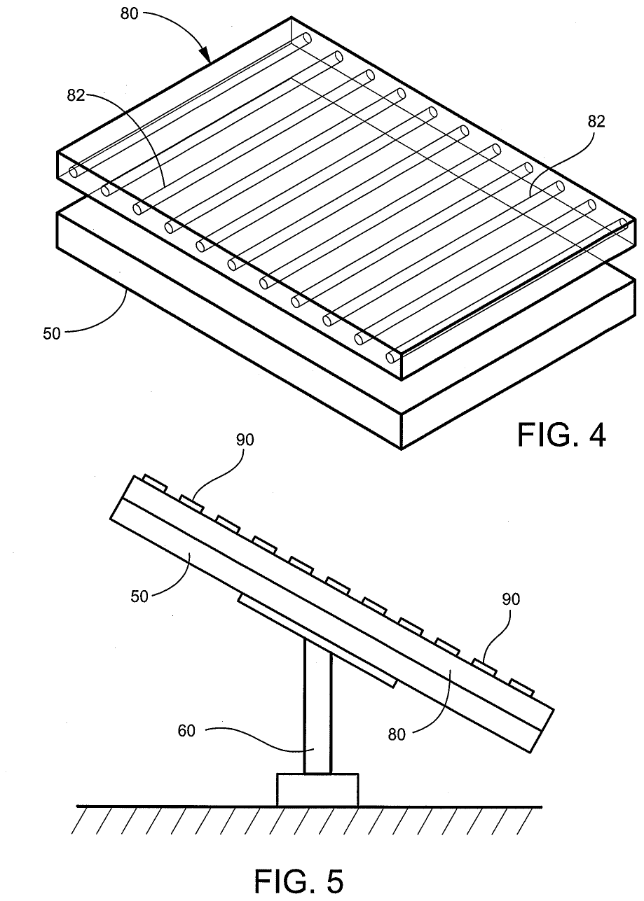

Referring to FIG. 4, one embodiment of cleaning solar panels is illustrated. In this embodiment, the cleaning device 80 includes a clear panel layer having multi-functional electrodes 82. The electrodes 82 may be constructed to include multiple elements which allow for multiple functional operations. The electrodes 82 may be activated to act as heating elements to melt snow or ice. Alternatively, electrodes 82 may be activated for forming an electrostatic field that repels dust or dirt.

FIG. 5 illustrates another embodiment of the self-cleaning device 80. In this embodiment heating elements 90 are mounted on the surface of device 80 rather than being embedded in device 80. The heating elements 90 are activated to melt snow and ice when the blockage of sunlight due to snow and ice reaches a certain obstruction level. Similarly, when an obstruction of sunlight, due to dust or dirt, reaches a certain level, the electrodes 82 of cleaning device 80 are activated for causing an electromagnetic field across the surface of device 80 for removing the dust or dirt.

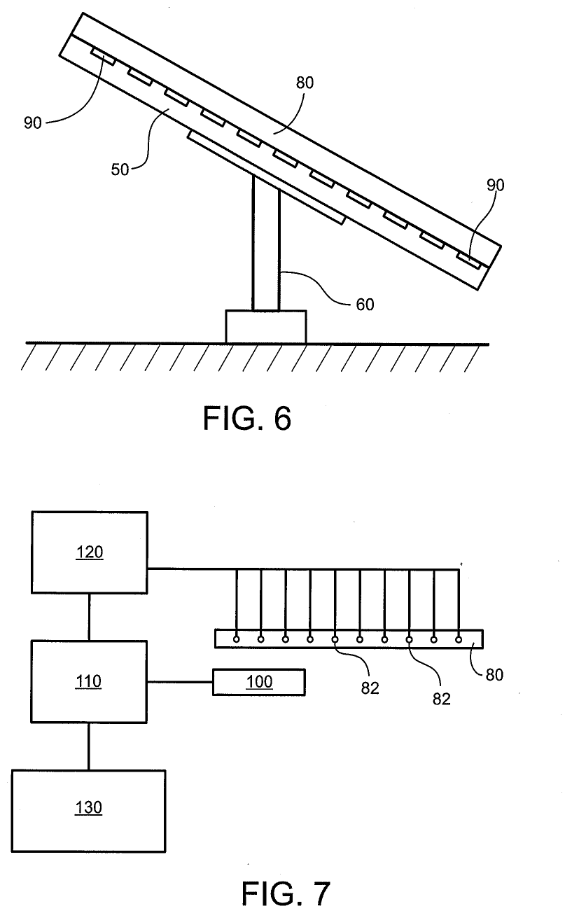

Another embodiment of self-cleaning device 80 is illustrated in FIG. 6. In this embodiment, heating elements 90 are mounted between device 80 and solar panel 50. The heating elements 90 are activated to melt snow and ice when a certain obstruction level is reached that is due to snow and ice. Alternatively, an electromagnetic or electrostatic wave is caused by electrodes 82 in device 80 when an unacceptable obstruction level is reached that is due to dust or dirt.

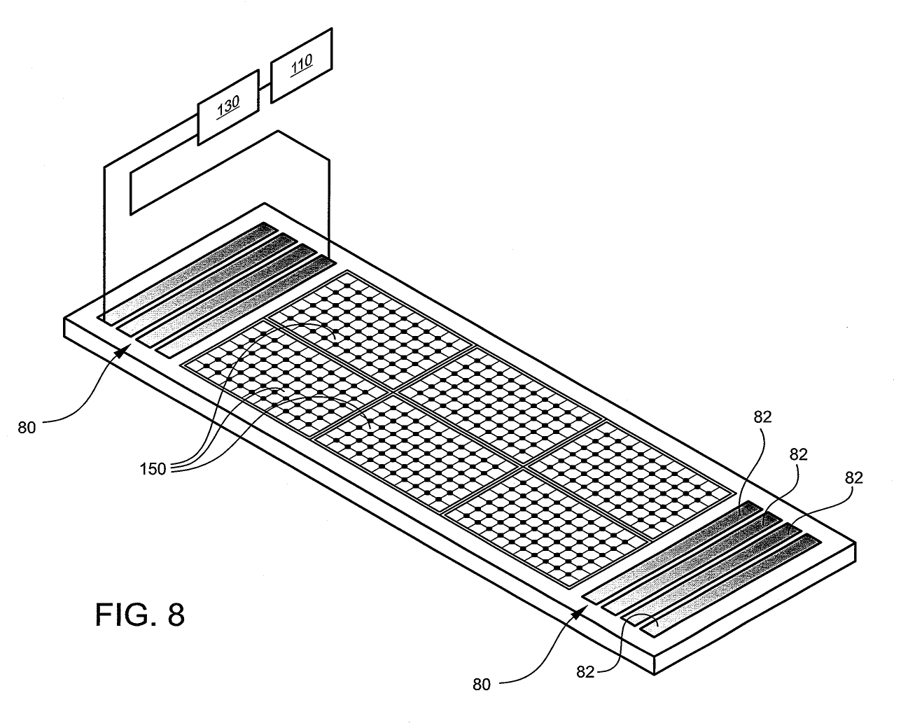

As previously described, and now more particularly described in connection with FIGS. 7-8, the present invention is related to methods for reducing the power consumption that is required for the cleaning of snow, ice, or dust from solar panels.

Referring to FIG. 7, sensors 100 are connected to each solar panel 50 to determine when the solar panels are obstructed by snow, ice, or dust, such that the obstruction prevents the panels from operating normally, i.e., operating to produce a normal threshold level of electricity. Sensors 100 detect the location, size, and type of an obstruction on the array of solar cell panels 50.

A controller 110 receives information from the sensors 100 and also receives other information including weather conditions, weather forecasts, and information relating to time, date, and temperature. The collection of information is evaluated by the controller 110.

If the collection of information evaluated by controller 110 results in a determination that snow or ice accumulation obstructs some or all of the solar panels 50, controller 110 generates a command signal that is sent to snow and ice controller 130. Controller 130 activates the electrodes 82 or heating elements 90 for one or more selected solar panels for melting the snow or ice obstruction from the selected panels.

If the collection of information processed by controller 110 results in a determination that dust or dirt obstructs some or all of the solar panels, controller 110 generates a command signal that is sent to dust controller 120. As shown schematically in FIG. 7, controller 120 provides a multi-phase alternating current signal to electrodes 82 which produces an electromagnetic field for removing the dust or dirt obstruction.

As shown in FIG. 8 and also in FIGS. 4-6, the electrodes 82 on device 80 or elements 90 may be of any desired shape or size, and they may be located at any desired location relative to the solar panels. FIG. 8, for example, shows the electrodes 82 at locations on panel 50 that are spaced from the photovoltaic modules 150.

As described previously, the methods of the present invention use heated cleaning devices 90 and/or multi-functional cleaning devices 82 for removing snow, ice, or dust from solar panels 50. In accordance with the methods of the present invention, an initial group of obstructed solar panels are selected for cleaning. The cleaning devices (either 90 or 82) for the initial group of solar panels are used to remove snow, ice, or dust from the selected solar panels. After the initially selected obstructed solar panels are cleaned, the power generated by the cleaned solar panels provides power for operating the cleaning devices for the next group of selected obstructed solar panels.

As described previously, the sensors 100 are used to detect information such as the type, location, and size of obstruction. The information gathered by the sensors 100 is transmitted to the controller 110.

The controller 110 evaluates information including the power output of the array of solar panels compared to the normal threshold level; the sensor detection information; information regarding the date, time, and temperature; and information regarding the weather conditions and weather forecasts. Sensors 100 are not activated until the power output of the array of solar panels falls below the array's normal operating or threshold level.

The collection of gathered information is processed by the controller 110 for the purpose of determining when to activate one or more of the cleaning devices and where to activate one or more of the cleaning devices. An initial cleaning location, having obstructed solar panels, is selected, and a group of cleaning devices for those obstructed solar panels are selected. The selected cleaning devices, in the selected cleaning location, are then activated to remove the obstruction from the selected group of obstructed solar panels.

After the initial selected group of obstructed solar panels is cleaned, new groups of obstructed solar panels are incrementally and sequentially selected and then cleaned.

A purpose for selecting the initial cleaning location is to make the cleaning process more efficient. If, for example, the obstruction does not cover the entire array of solar cells, it is more efficient to first activate cleaning devices at cleaning locations that are obstructed. Alternatively, if the obstruction covers most or all of the solar panel array, the cleaning location may be the entire solar panel array, and the controller 110 would initially select a first group of obstructed solar panels; activate the cleaning devices for the first group of obstructed solar panels until the first group is cleared of obstruction; and then incrementally and sequentially select and activate subsequent groups of cleaning devices in cleaning locations on the solar panel array that still have obstruction.

After the first group of solar panels are cleaned of snow, ice, or dust, a second group of obstructed solar panels are selected and cleaned by using, at least in part, the power being generated by the first group of cleaned solar panels. A second group of obstructed solar panels is selected and thereafter, incrementally and sequentially, additional groups of obstructed solar panels are selected. The cleaning devices for those incrementally and sequentually selected groups of obstructed solar panels are activated. The method of cleaning obstructed solar panels, as described herein, continues until the entire array of solar panels is cleaned.

The present invention may be embodied in other forms without departing from the spirit and the attributes thereof, and, accordingly, reference should be made to the appended claims, rather than to the foregoing specification, as indicative of the scope of the invention.

1. A method of cleaning an obstruction from
operating surfaces on an array of solar panels that produce a normal threshold level of electricity output wherein each solar panel is capable of generating electricity and at least one solar panel includes a cleaning device for removing the obstruction, the method comprising the steps of:
sensing an existence of the obstruction on all or a part of the operating surfaces of the array of solar panels:
determining when the sensed obstruction reduces the electricity output of the solar panel array to a level that is below the normal threshold level;
sensing and evaluating the location of the obstruction after determining that the electricity output from the solar panel array is below the normal threshold level;
selecting a cleaning area on the array of solar panels, said cleaning area being within the sensed and evaluated location of the obstruction;
selecting a first group of solar panels that are located within the selected
cleaning area, the first group of selected solar panels each having the cleaning device, and selecting the first group of solar panels after the electricity output falls below the normal threshold level;
activating the cleaning device for the first group of solar panels to remove the obstruction from the first group of solar panels;
selecting a second group of solar panels having the cleaning device after the obstruction for the first group of solar panels has been removed;
activating the cleaning device on the second group of solar panels to remove the obstruction on the second group of solar panels;
incrementally and sequentially selecting additional groups of solar panels having the cleaning device, and incrementally and sequentially activating the cleaning device on the additional selected groups of solar panels until the operating surfaces of the solar panel array are cleaned; and
generating electrical power using the cleaned solar panels and using the power generated by the cleaned solar panels to power, in whole or in part, the cleaning device for the incrementally and sequentially selected groups of solar panels that require cleaning.

2. (canceled)

3. The method of cleaning obstructions from an array of solar panels according to claim 1 further comprising sensing and evaluating the size and type of obstruction on the solar panels after determining that the electricity output from the solar panel array is below the normal threshold level.

4. The method of cleaning obstructions from an array of solar panels according to claim 3 further comprising evaluating weather conditions, weather forecasts, date, time, and temperature after determining the size and type of the obstruction.

5. The method of cleaning obstructions from an array of solar panels according to claim 1 further comprising activating the cleaning device on each selected solar panel if snow or ice obstruction is detected.

6. The method of cleaning obstructions from an array of solar panels according to claim 1 further comprising activating the cleaning device on each selected solar panel if dust obstruction is detected.

7. The method of cleaning obstructions from an array of solar panels according to claim 1 further comprising activating the cleaning device on each selected solar panel to remove either snow, ice, or dust obstruction.

8. (canceled)
